(19) United States
(12) Patent Application Publication
(10) Pub. No.: US 2024/0241814 A1
(43) Pub. Date: Jul. 18, 2024

(54) SYSTEM AND METHOD FOR AUTOMATED TEST SCRIPT CODE GENERATION FOR SOFTWARE QUALITY ASSURANCE

(71) Applicant: Xoriant Corporation, Sunnyvale, CA (US)

(72) Inventors: Madhavi SAMPAT, Mumbai (IN); Ridhdesh SHELAR, Pune (IN); Girish Gaitonde, Saratoga, CA (US)

(21) Appl. No.: 18/096,633

(22) Filed: Jan. 13, 2023

(51) Int. Cl. G06F 11/36; G06N 20/00

(52) U.S. Cl. CPC G06F 11/3684; G06F 11/3664; G06N 20/00

(57) ABSTRACT

A system and method for automated test script code generation for software quality assurance are disclosed. A particular embodiment is configured to: establish, by use of a data processor and a data network, a data connection with a web elements repository; upload, by use of the data processor, a web elements repository file to the web elements repository for a webpage under consideration; provide a collection of autonomous computer programs or bots configured to automatically perform a specific software test life cycle (STLC) task; use a bot of the collection of bots to prompt, by use of the data processor, a user to enter an utterance corresponding to the STLC task; match, by use of the data processor, the utterance to commands and web elements corresponding to the webpage under consideration; generate, by use of the data processor, an executable test code block corresponding to the matched command and web elements; and integrate, by use of the data processor, the executable test code block into an executable test script, which can be used to automatically test a software module.

### COPYRIGHT

A portion of the disclosure of this patent document contains material that is subject to copyright protection. The copyright owner has no objection to the facsimile reproduction of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2019-2022 Xoriant Corporation, All Rights Reserved.

### TECHNICAL FIELD

This patent application relates to computer-implemented software systems, according to one embodiment, and more specifically to a system and method for automated test script code generation for software quality assurance.

### BACKGROUND

With the progression in software validation processes, a test automation framework has become a need when it comes to the software quality assurance (QA) automation. There are at least two main challenges that organizations face while following the tasks and processes defined in most test validation efforts. The first challenge is to ensure that standards laid down are followed so that the cost of rework is minimized, and test design productivity is highest with minimal technical Knowledge. The second challenge is to automate as much of the Software Testing Life Cycle (STLC) as possible, with limited skilled resources. In the scenario of frequent software releases in an agile technical world, quality assurance (QA) engineers tend to focus on immediate release candidates and sacrifice a focus on integrated functionality. As a result, software quality is compromised and automation coverage is reduced over the time. As such, STLC automation in conventional software systems has proven to be very difficult to implement.

### SUMMARY

In various example embodiments described herein, a system and method for automated test script code generation for software quality assurance is disclosed. In the various example embodiments described, a computer-implemented tool or software application (app) as part of an automated software testing system is described to automate and improve the STLC. As described in more detail below, a computer or computing system on which the described embodiments can be implemented can include any type of computing, data processing, communication, networking, or electronic system capable of executing software.

In various example embodiments described herein, the automated software testing system provides a series of automated processes to facilitate and enhance the various phases of the STLC. In a particular example embodiment, the automated processes can be implemented as or with bots or autonomous computer programs on a computer system or network that can interact with computer system processes or users. In the particular example embodiment, the bots can be implemented using machine learning techniques, trained deep neural networks, classifiers, or other types of trainable execution models. Bots are particularly well-suited to reacting quickly to a specific and dynamic STLC environment. Also, given the automation provided by the bots of an example embodiment, the various phases of the STLC can be implemented around the clock thereby improving the quality of software being developed and speeding the STLC to earlier completion.

In an example embodiment of the automated software testing system, the conventional STLC processes can be integrated with a collection of bots, which span across each phase of the STLC. The use of automation and bots enables continuous code inspection, testing and deployment. The automated software testing system of an example embodiment can automate repetitive tasks, implement model processes and best practices, validate work performed by human engineers, and enable the use of automated tools and technology for different phases of the STLC.

In various example embodiments described herein, an automated software testing system assists Quality Assurance (QA) Automation engineers generate test scripts automatically. The disclosed automated software testing system enables users to chat with a Bot with the help of predefined/configured commands so that the system can generate corresponding test code at the backend automatically. The generated test code is ready to use and pluggable into a test suite. The disclosed automated software testing system can integrate with any automation framework so that automation engineers can leverage utility methods of the framework inside the Bot. The disclosed automated software testing system enables people from a non-automation background to write testcases and become more productive.

The various example embodiments described herein provide several advantages over conventional systems including: 1) Automation test scripts can be generated using a chat interface; 2) The disclosed testing system implements machine learning techniques for identifying intents of the utterances by users to suggest a closest match for commands; 3) Code generated by the chatbot (e.g., the generated test code or automation test script) is ready-to-use; 4) The disclosed testing system provides a Low-Code-No-Code solution, which helps write testcases faster; 5) The disclosed testing system reduces the requirement for skilled automation engineers in a project; and 6) The disclosed testing system provides an easy to use interface with auto suggestions for utterances and a locator repository, which leads to reduced turnaround time for test script design.

Details of the various example embodiments are disclosed in more detail below.

### BRIEF DESCRIPTION OF THE DRAWINGS

The various embodiments are illustrated by way of example, and not by way of limitation, in the figures of the accompanying drawings in which:

FIG. 1 illustrates a collection of bots that may be used in an example embodiment;

FIG. 2 illustrates an example embodiment of a networked system in which various embodiments may operate;

FIG. 3 illustrates a use case of an example embodiment wherein several types of users may interact with the automated software testing system;

FIG. 4 illustrates an example embodiment showing the interaction between the portal processing module and the bot collection;

FIG. 5 illustrates an example embodiment showing how the conventional STLC processes can be integrated with a collection of bots, which span across each phase of the STLC;

FIG. 6 illustrates an architecture and operational flow of an example embodiment;

FIG. 7 illustrates an example embodiment implemented using the LUIS™ API service in the framework;

FIG. 8 illustrates a processing flowchart in an example embodiment;

FIGS. 9 through 13 illustrate sample user interface screenshots in use case scenarios of example embodiments of the automated software testing system;

FIG. 14 illustrates an example embodiment showing a training system platform and a process for training each of the bots in the collection of bots;

FIG. 15 illustrates another example embodiment of a networked system in which various embodiments may operate;

FIG. 16 illustrates a processing flow diagram that illustrates an example embodiment of a method as described herein; and

FIG. 17 shows a diagrammatic representation of a machine in the example form of a computer system within which a set of instructions when executed may cause the machine to perform any one or more of the methodologies discussed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

In various example embodiments described herein, a system and method for automated test script code generation for software quality assurance is disclosed. In the various example embodiments described, a computer-implemented tool or software application (app) as part of an automated software testing system is described to automate and improve the STLC. As described in more detail below, a computer or computing system on which the described embodiments can be implemented can include any type of computing, data processing, communication, networking, or electronic system capable of executing software.

In various example embodiments described herein, the automated software testing system provides a series of automated processes to facilitate and enhance the various phases of the STLC. In a particular example embodiment, the automated processes can be implemented as or with bots or autonomous computer programs on a computer system or network that can interact with computer system processes or users. In the particular example embodiment, the bots can be implemented using machine learning techniques, trained deep neural networks, classifiers, or other types of trainable execution models. Bots are particularly well-suited to reacting quickly to a specific and dynamic STLC environment. Also, given the automation provided by the bots of an example embodiment, the various phases of the STLC can be implemented around the clock thereby improving the quality of software being developed and speeding the STLC to earlier completion.

In an example embodiment of the automated software testing system, the conventional STLC processes can be integrated with a collection of bots, which span across each phase of the STLC. The use of automation and bots enables continuous code inspection, testing and deployment. The automated software testing system of an example embodiment can automate repetitive tasks, implement model processes and best practices, validate work performed by human engineers, and enable the use of automated tools and technology for different phases of the STLC.

In various example embodiments described herein, an automated software testing system assists Quality Assurance (QA) Automation engineers generate test scripts automatically. The disclosed automated software testing system enables users to chat with a Bot with the help of predefined/configured commands so that the system can generate corresponding test code at the backend automatically. The generated test code is ready to use and pluggable into a test suite. The disclosed automated software testing system can integrate with any automation framework so that automation engineers can leverage utility methods of the framework inside the Bot. The disclosed automated software testing system enables people from a non-automation background to write testcases and become more productive.

The various example embodiments described herein provide several advantages over conventional systems including: 1) Automation test scripts can be generated using a chat interface; 2) The disclosed testing system implements machine learning techniques for identifying intents of the utterances by users to suggest a closest match for commands; 3) Code generated by the chatbot (e.g., the generated test code or automation test script) is ready-to-use; 4) The disclosed testing system provides a Low-Code-No-Code solution, which helps write testcases faster; 5) The disclosed testing system reduces the requirement for skilled automation engineers in a project; and 6) The disclosed testing system provides an easy to use interface with auto suggestions for utterances and a locator repository, which leads to reduced turnaround time for test script design.

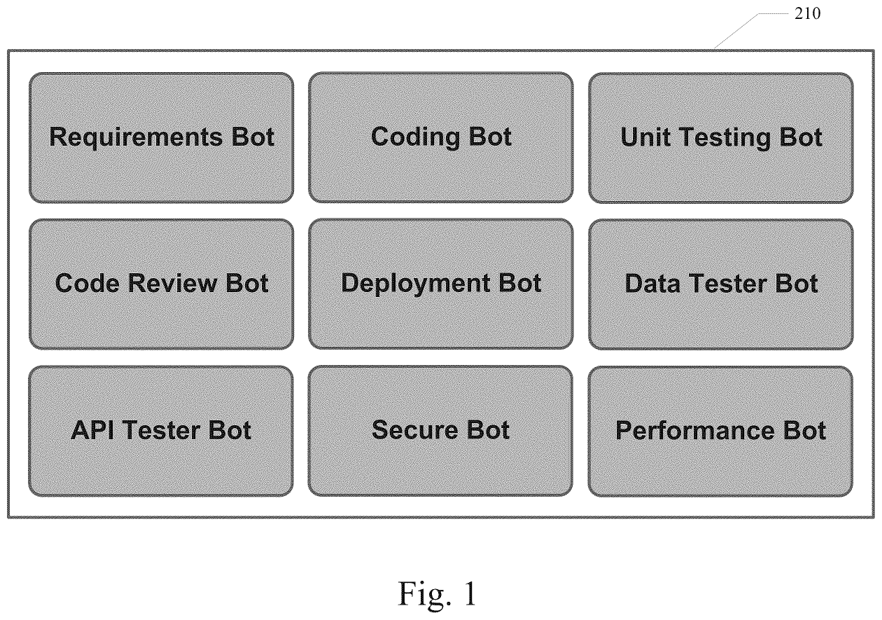

FIG. 1 illustrates a collection of bots 210 of an example embodiment of the automated software testing system as disclosed herein. Each of these bots in the collection of bots 210 is described in more detail below along with the automated software testing system 200 in which the bots 210 are executed and managed. A typical SDLC includes several phases: 1) a software design and coding phase, 2) a software testing phase, and 3) a software system deployment phase. It will be apparent to those of ordinary skill in the art that additional SDLC phases can also be implemented using the techniques described herein. As shown in FIG. 1, a bot can be provided to perform code review and coding style checking on completed software modules. Other bots can be provided to perform an analysis on completed software modules pertaining to a level of compliance with security standards or practices. In each case, the bots can be configured as rule-based automated processing modules or trained machine learning automated processing modules. The training of the machine learning, neural network, or classifier bots is described in more detail below. The bots supporting the software design and coding phase of the SDLC can analyse completed software modules or automatically generate executable code in serial or in parallel and may be executed around the clock to significantly speed up the automatic generation and validation of the designed and coded software modules during the software design and coding phase.

Referring still to FIG. 1 for an example embodiment, the software testing phase of the STLC can also be supported by a collection of automated testing bots. The testing phase is intended to perform a battery of tests on completed software modules that have been validated by the software design and coding phase as described above. One tedious and error-prone task of the testing phase is the generation of test cases and test data to stress the functionality and implementation of the validated software modules by executing the test cases and capturing output produced by the software modules under test. This output must be compared against benchmarks or acceptable output definitions. The software modules not complying with testing standards are flagged and automatic notifications or alerts can be generated. Then, each software module under test can be evaluated and test results can be recorded and/or communicated. In an example embodiment, a data tester bot and an application programming interface (API) tester bot can be provided to evaluate the software modules and interfaces under test against applicable code review standards or desired profile definitions. As in the software design and coding phase, the bots used in the testing phase can be configured as rule-based automated processing modules or trained machine learning automated processing modules. The bots supporting the software testing phase of the STLC can automatically generate test cases, test data, test sequencing, and can automatically run the test sequences against software modules under test in serial or in parallel. The performance of each of the software modules under test can be evaluated and recorded. The testing phase bots may be executed around the clock to significantly speed up the automatic testing of the designed and coded software modules during the software testing phase.

Referring still to FIG. 1 for an example embodiment, the software deployment phase of the SDLC can also be supported by a collection of automated deployment bots. The deployment phase is intended to assemble multiple validated and tested software modules into a functional and operable software system. The analysis and validation of interfaces between the plurality of modules of the software system is a key part of this phase of the SDLC. An example embodiment can provide automated bots to analyse and test these interfaces, including the APIs as in the testing phase. The interfaces can be tested and evaluated by the bots for accuracy and efficiency. Metrics can be automatically captured by bots to determine speed, throughput, capacity, and other performance metrics of the integrated software system. Bots can also evaluate the functionality, operation, and efficiency of the software system against pre-established requirements parameters. As in the software design and coding phase and the testing phase, the bots used in the deployment phase can be configured as rule-based automated processing modules or trained machine learning automated processing modules. The bots supporting the software deployment phase of the SDLC can automatically generate interface test scenarios, interface test sequencing, and can automatically run interface tests with groups or sub-groups of software modules under test in serial or in parallel. The performance of each of the groups of software modules under test can be evaluated and recorded. The deployment phase bots may be executed around the clock to significantly speed up the automatic testing of the software system during the software deployment phase.

It is important for software project managers and senior management to know about the status of the development and deployment of a particular software system project without getting into the low-level details. The various example embodiments described herein calculate the health and status of the software system project based on various metrics. The various example embodiments can also predict the health and status based on the domain, technology, requirements and the reported issues. The various example embodiments can also provide an estimated timeline to complete the software system project. In particular, the example embodiments can provide: Quantitative project management, including: 1) Process metrics—defect metrics, velocity (team vs. individuals), and delivered vs. committed percentages, 2) Code metrics—technical debt, maintainability indices, code coverage, and complexity indices, and 3) Project Health—a combination of process metrics, code metrics, and utilization (human and financial) to calculate project health. The various example embodiments can also provide quality trends or trending data, including generation of sprint-wise trends based on the above metrics, and trend analysis based on the quality of builds and the costs of build failures.

As described above, the various example embodiments can automate many of the steps in the STLC. These automated steps can include: automated user interface (UI) style testing, automated static and security code analysis, automated unit test case generation, automated API test code generation, automated API documentation, automated test data generation, automated regression and performance tests, automated build verification tests, test execution results, and automated API testing. It will be apparent to those of ordinary skill in the art in view of the disclosure herein that other steps of the STLC can also be similarly automated.

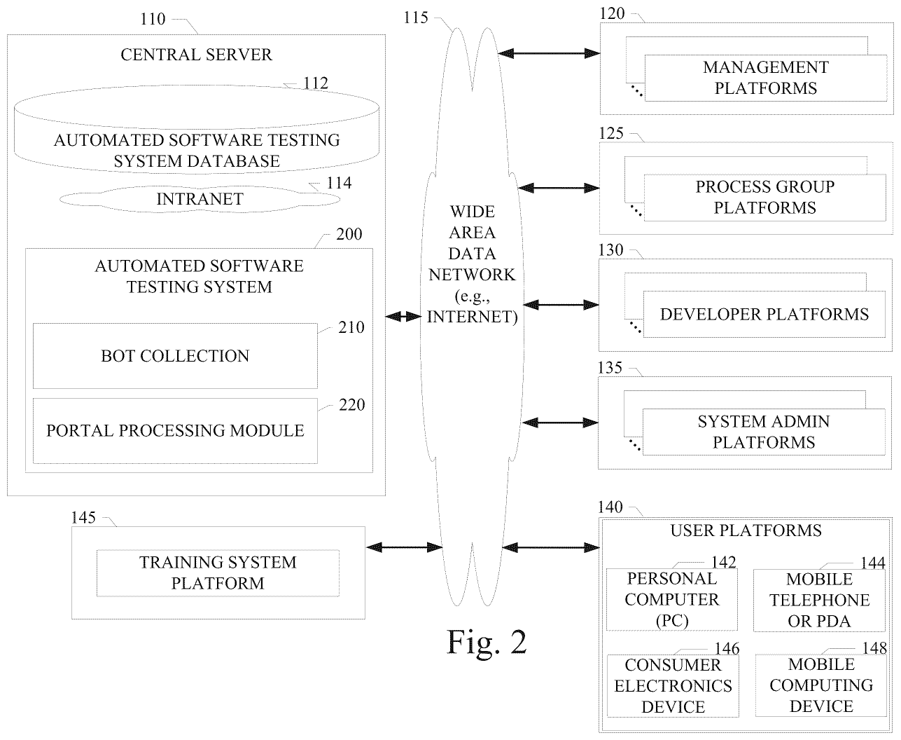

Referring now to FIG. 2 in an example embodiment, an automated software testing system 200 can be implemented as described herein to support the automation of the SDLC. In the example embodiment, the automated software testing system 200 can include the collection of automated processing modules or bots 210 as described above. Additionally, the automated software testing system 200 can include a portal processing module 220 to provide user interfaces, dashboards, administrative controls, and interfaces for controlling the bots of the bot collection 210 of the automated software testing system 200.

In the example embodiment as shown in FIG. 2, the automated software testing system 200 can be deployed on a central server or host site (e.g., a website) 110 to provide a system and method for automated test script code generation for software quality assurance. For many on-site projects, a shared server (not shown) can be provided and interfaced with central server 110. For off-site projects, such as client Offshore Development Centers (ODCs), a deployment in the client environment, such as an application (app), can be provided and interfaced with central server 110. To remove the app installation complexity, a containerized application can be provided to the client, which can be readily set up. Users at the client sites (120, 125, 130, 135, and 140) can be provisioned with and can provide the credentials to access the app and/or the server 110. All configuration for tools can be managed via a user interface. Users can have the option to view app metrics data based on their user roles. In various example embodiments, the automated software testing system 200 can be hosted by the host site 110 for a networked user at any of the client sites (120, 125, 130, 135, and 140), wherein any of the client sites (120, 125, 130, and 135) can be implemented as a user platform 140. The details of the automated software testing system 200 and client sites (120, 125, 130, 135, and 140) for an example embodiment are provided below.

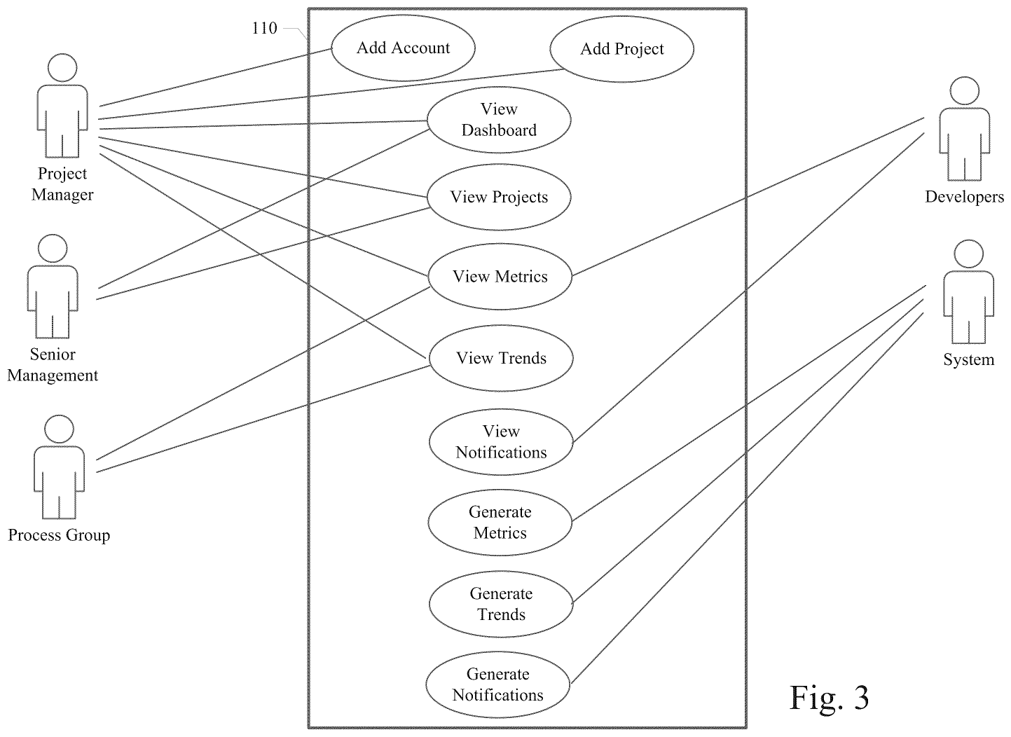

Referring again to FIG. 2 and to FIG. 3, the automated software testing system 200 can be in network communication with a plurality of client sites (120, 125, 130, 135, and 140). These client sites can include management platforms 120, process group platforms 125, developer platforms 130, or system administrative platforms 135. The management platforms 120 can include access portals for project managers or senior management personnel to create new accounts or projects and to view the status metrics and trends of on-going software development projects. The process group platforms 125 can include access portals for process group managers to view the status metrics and trends of relevant SDLC processes of on-going software development projects. The developer platforms 130 can include access portals for software development personnel to view the status metrics and notifications of relevant SDLC software development tasks of on-going software development projects. The system administrative platforms 135 can include access portals for system administrative personnel to cause the generation of status metrics, trend data, and notifications for on-going software development projects.

The automated software testing system 200 can be configured to provide data communications for the user platforms 140 serving as networked platforms for project managers and senior management at management platforms 120, process group coordinators at process group platforms 125, software developers at developer platforms 130, and system administrators at system administrative platforms 135. The automated software testing system 200 can provide SDLC information in a digital or computer-readable form to these user platforms 140 via the network 115. The automated software testing system 200 can also be configured to provide data communications for the training system platforms 145 to enable the networked usage, transfer, or downloading of the bot collection 210. The bot collection 210 may initially reside with a training system platform 145 or may be downloaded to or from the host site 110. In other words, the bot collection 210 may be trained, tested, used, transferred, or uploaded to the host site 110 and the automated software testing system 200 therein via the network 115.

One or more of the management platforms 120, the process group platforms 125, the developer platforms 130, and the system administrative platforms 135 can be provided by one or more third party SDLC contributors operating at various locations in a network ecosystem. The host site 110, management platforms 120, process group platforms 125, the developer platforms 130, and the system administrative platforms 135 can be implemented from a variety of different types of client devices, such as user platforms 140. The user platforms 140 may communicate and transfer data and information in the data network ecosystem shown in FIG. 2 via a wide area data network (e.g., the Internet) 115. Various components of the host site 110 can also communicate internally via a conventional intranet or local area network (LAN) 114.

Networks 115 and 114 are configured to couple one computing device with another computing device. Networks 115 and 114 may be enabled to employ any form of computer readable media for communicating information from one electronic device to another. Network 115 can include the Internet in addition to LAN 114, wide area networks (WANs), direct connections, such as through a universal serial bus (USB) port, other forms of computer-readable media, or any combination thereof. On an interconnected set of LANs, including those based on differing architectures and protocols, a router and/or gateway device acts as a link between LANs, enabling messages to be sent between computing devices. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communication links known to those of ordinary skill in the art. Furthermore, remote computers and other related electronic devices can be remotely connected to either LANs or WANs via a wireless link, WiFi, Bluetooth™, satellite, or modem and temporary telephone link.

The management platforms 120, process group platforms 125, developer platforms 130, and system administrative platforms 135 may produce and consume any of a variety of network transportable digital data. The network transportable digital data can be transported in any of a family of file formats and associated mechanisms usable to enable a host site 110 to exchange data with the management platforms 120, the process group platforms 125, the developer platforms 130, and the system administrative platforms 135.

In a particular embodiment, a user platform 140 with one or more client devices enables a user to access data provided by the automated software testing system 200 via the host 110 and network 115. Client devices of user platform 140 may include virtually any computing device that is configured to send and receive information over a network, such as network 115. Such client devices may include portable devices 144, such as, cellular telephones, smart phones, camera phones, display pagers, radio frequency (RF) devices, infrared (IR) devices, global positioning devices (GPS), Personal Digital Assistants (PDAs), handheld computers, wearable computers, tablet computers, integrated devices combining one or more of the preceding devices, and the like. The client devices may also include other computing devices, such as personal computers 142, multiprocessor systems, microprocessor-based or programmable consumer electronics, network PC's, and the like. The client devices may also include other processing devices, such as consumer electronic (CE) devices 146 and/or mobile computing devices 148, which are known to those of ordinary skill in the art. As such, the client devices of user platform 140 may range widely in terms of capabilities and features. Moreover, the web-enabled client device may include a browser application enabled to receive and to send wireless application protocol messages (WAP), and/or wired application messages, and the like. In one embodiment, the browser application is enabled to employ HyperText Markup Language (HTML), Dynamic HTML, Handheld Device Markup Language (HDML), Wireless Markup Language (WML), WMLScript, JavaScript™, EXtensible HTML (xHTML), Compact HTML (CHTML), and the like, to display and/or send digital information. In other embodiments, mobile devices can be configured with applications (apps) with which the functionality described herein can be implemented.

Referring again to FIG. 2, the automated software testing system 200 of an example embodiment is shown to include an automated software testing system database 112. The database 112 can be used to retain a variety of information data sets including, but not limited to, software module information, metadata, provenance and versioning information, status, metrics, change histories, and the like. It will be apparent to those of ordinary skill in the art that the automated software testing system database 112 can be locally resident at the host site 110 or remotely located at other server locations or stored in network cloud storage.

Referring again to FIG. 2, host site 110 of an example embodiment is shown to include the automated software testing system 200. In an example embodiment, automated software testing system 200 can include a bot collection 210, and a portal processing module 220. Each of these modules can be implemented as software components executing within an executable environment of automated software testing system 200 operating on host site 110 or user platform 140. Each of these modules of an example embodiment is described in more detail below in connection with the figures provided herein.

Referring still to FIG. 2, the bot collection 210 can facilitate the automation of various phases of the SDLC as described above. The portal processing module 220 can provide user interfaces, dashboards, administrative controls, and interfaces for controlling the bots of the bot collection 210 of the automated software testing system 200. The bot collection 210 and the portal processing module 220 can be configured to perform the processing as described in more detail below. The bot collection 210 can be resident at the host site 110, resident at a remote client site, or partially resident on a plurality of user platforms 140. Similarly, the portal processing module 220 can be resident at the host site 110 or partially resident on one or more user platforms 140. The automated software testing system 200 be configured to provide data communications for the client sites (120, 125, 130, 135, and 140) to enable the networked usage, transfer, or downloading of information, executables, data, metrics, notifications, images, documents, and related data to facilitate the various phases of the SDLC. The components and processes for automating the SDLC as embodied in the bot collection 210 and the portal processing module 220 are described in more detail below.

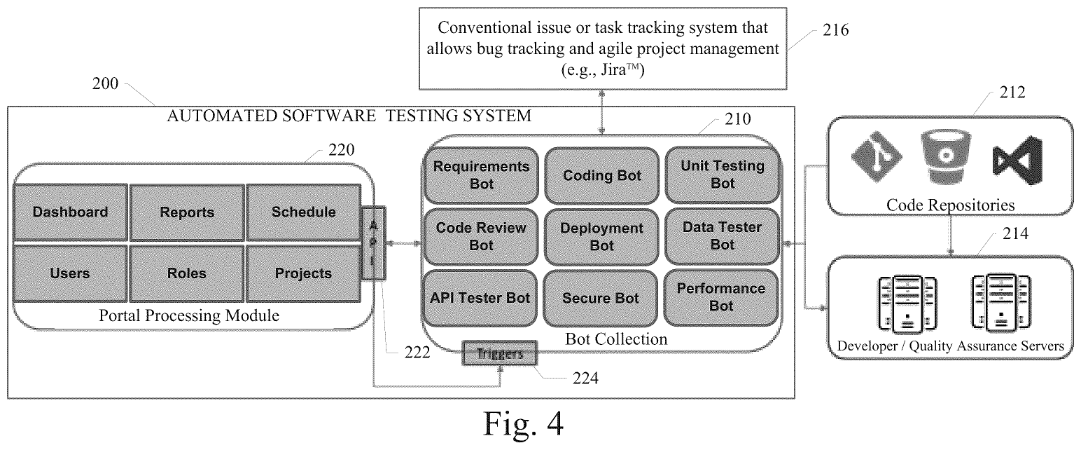

FIG. 4 illustrates a framework of an example embodiment of the automated software testing system 200 that includes the portal processing module 220 and the collection of bots 210. In particular, FIG. 4 illustrates the example embodiment showing the interaction between the portal processing module 220 and the bot collection 210. As shown, an application programming interface (API) 222 enables data communication between the portal processing module 220 and the bot collection 210. In one example embodiment, the portal processing module 220 can use triggers 224 to activate or otherwise control any of the bots of bot collection 210. In other example embodiments, a scheduler or daemon can be used to activate or otherwise control any of the bots of bot collection 210 for execution at a pre-defined time (e.g., daily, weekly, monthly, or on a one-time or repeating custom schedule). As described in more detail below, the portal processing module 220, and the users connected thereto, can drive the various phases of the SDLC and activate any of the bots of bot collection 210 at appropriate times to automate tasks of the various phases of the SDLC. The automated software testing system 200 can also have access to code repositories 212 and servers, networks, or other computing environments 214 of the code developers and quality assurance (QA) personnel. The software being developed, tested, and deployed by the automated software testing system 200 can be stored and accessed in the code repositories 212 and servers, networks, or other computing environments 214. Additionally, an example embodiment of the automated software testing system 200 can include an interface to a conventional issue or task tracking system 216 that allows bug tracking and agile project management (e.g., Jira™). In this manner, the automated software testing system 200 can automatically create action items or requests resulting from the SDLC processing, wherein the action items can be tasked, tracked, and resolved through the conventional issue or task tracking system 216.

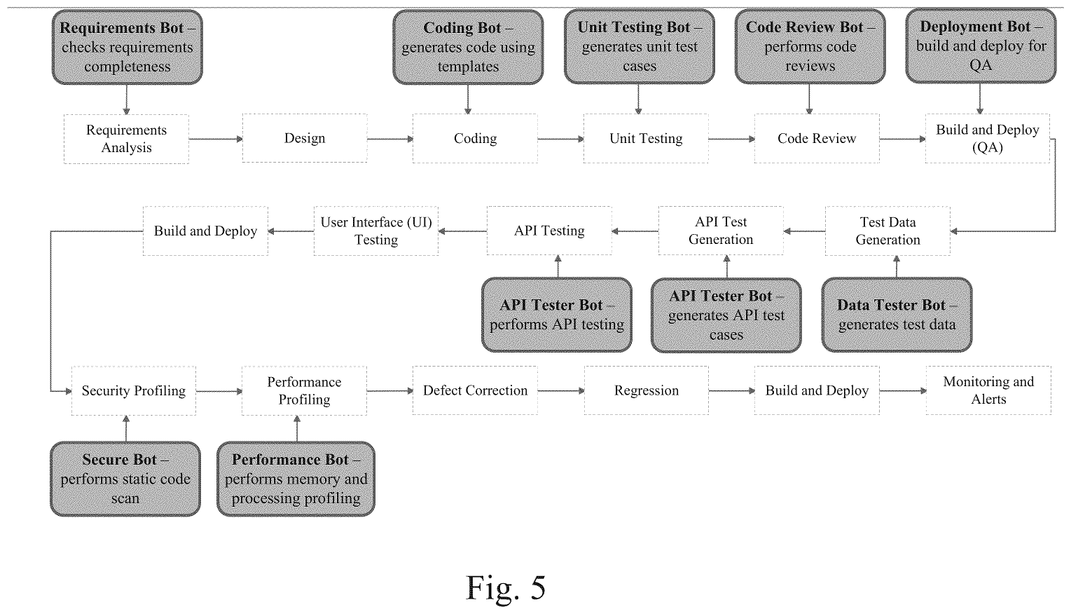

FIG. 5 illustrates the processes in various SDLC phases that can be replaced or augmented with a bot of bot collection 210 according to an example embodiment. As described herein, the various example embodiments can automate many of the steps in the SDLC. As illustrated by the dashed boxes shown in FIG. 5, these steps of the conventional SDLC can include: software requirements analysis, software design and coding, software module unit testing, code review, creation of builds and deployment for quality assurance testing, test data generation, application programming interface (API) test generation and API testing, user interface (UI) testing, creation of builds and deployment for internal testing, security profiling, performance profiling, defect correction, regression testing, creation of builds and deployment for production release, and monitoring and alert handling tasks. It will be apparent to those of ordinary skill in the art in view of the disclosure herein that other steps of the SDLC can also be similarly implemented.

As also illustrated by the solid-line, rounded corner boxes shown in FIG. 5, these steps of the conventional SDLC can be automated or improved by automation using one or more of the bots of bot collection 210. For example, a Requirements Bot of bot collection 210 can be configured to automatically scan a software requirements specification for completeness, consistency, and standards compliance. A Coding Bot can be configured to automatically scan coded software modules for standards compliance, appropriate data definitions, case and branch handing, exception handling, variable or symbol mismatches, parameter range checking, non-initialized variables, and the like. As shown in FIG. 5, a Unit Testing Bot can be configured to generate unit test cases for testing coded software modules. Another bot, a Code Review Bot, can be provided to perform code review and coding style checking on completed software modules. A Deployment Bot can be configured to automatically create software system builds and deployments for QA testing. A Data Tester Bot can be configured to generate test data to test the QA build. An API Tester Bot can be configured to generate API test cases and to perform testing of the API. A Secure Bot can be configured to automatically perform static code scanning on the software build to detect malware. Finally, as shown in FIG. 5, a Performance Bot can be configured to perform memory and execution profiling on the software build to determine a level of system performance and efficiency. Other bots can be provided to perform an analysis on completed software modules pertaining to a level of compliance with security standards or practices, proper coding standards, software requirements compliance, regulatory compliance, and the like. In each case, the bots can be configured as rule-based automated processing modules or trained machine learning automated processing modules. The training of the machine learning, neural network, or classifier bots is described in more detail below. The bots supporting each phase of the SDLC can analyse and test completed software modules, builds, and interfaces in serial or in parallel and may be executed around the clock to significantly speed up the automatic validation of the designed, coded, tested, and deployed software system.

In addition, example embodiments can also provide automated software module deployment, API documentation, automated test data generation, automated regression and performance testing, automated build verification testing, test execution results, and automated API testing. It will be apparent to those of ordinary skill in the art in view of the disclosure herein that other steps of the SDLC can also be similarly automated. As a result, the example embodiments disclosed herein provide an automated SDLC/STLC and an Integrated Development Environment (IDE).

### Details of Various Example Embodiments of the Automated Software Testing System

In various example embodiments described herein, a system and method for automated test script code generation for software quality assurance is disclosed. In the various example embodiments described, a computer-implemented tool or software application (app) as part of an automated software testing system is described to automate and improve the STLC. In the disclosed example embodiments, a chatbot is integrated with an automation testing framework for generating automation code for testcases. The chatbot implements machine learning techniques, trained deep neural networks, classifiers, or other types of trainable execution models for this purpose. In the example embodiment, the automation testing framework is integrated with chatbot to enable the library methods of the framework to be available in the chatbot. As a result, the test scripts automatically generated by the Bot are compatible with any framework used for integration.

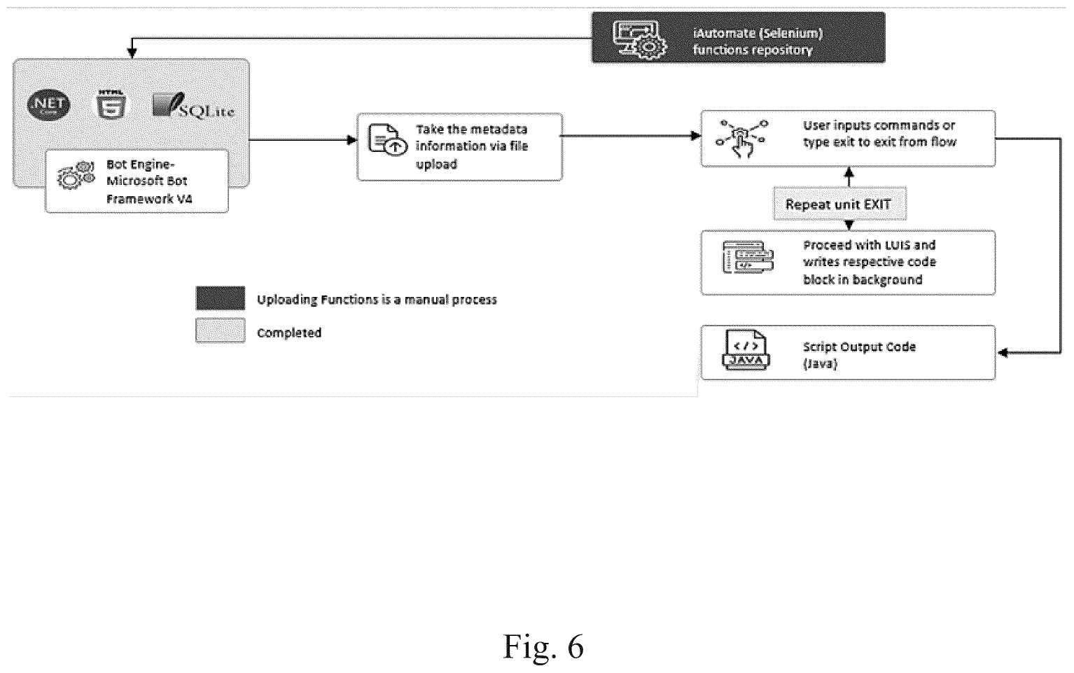

Referring now to FIG. 6, an architecture and operational flow of an example embodiment is illustrated. In various example embodiments described herein, the Automated Software Testing System uses a Bot Engine based on Microsoft™ Bot Framework V4. It will be apparent to those of ordinary skill in the art that other conventional Bot frameworks can be similarly used. In operation, a user is prompted to type or speak a series of utterances/commands in a chat window of a user interface, which in turn causes generation of a test script at the backend. As a first step, the user is prompted to upload the web elements repository file for the webpage under consideration. This repository file contains data related to locators, which identify elements on the webpage (e.g., Xpaths, CSS, etc). Chatbot extracts the web element from this file and uses the web element as metadata information. As the automation engineer starts typing utterances in the chat window, the most suitable and most appropriate utterances from the utterance library are fetched and made available from which the user may choose. In a particular embodiment, a Bot uses LUIS™ API service to identify an intent of the commands/utterances so that the closest match for the commands can be identified. The LUIS™ API is a well-known application programming interface (API), also known as Language Understanding (LUIS), which is a cloud-based API service using machine-learning to process conversational, natural language to predict meaning and extract information. The Bot allows the user to choose from the web element of the page under automation to complete the commands. For this purpose, the LUIS™ API service processes the metadata of the page that was uploaded as a first step. In response to the identification and selection of a closest match command, the Automated Software Testing System can generate an executable test code block corresponding to the selected command. The test code block can be integrated with script output code to run against a software application or module under test.

The various example embodiments described herein provide several advantages over conventional systems including: 1) Automation test scripts can be generated using a chat interface; 2) The disclosed testing system implements machine learning techniques for identifying intents of the utterances by users to suggest a closest match for commands; 3) Code generated by the chatbot (e.g., the generated test code or automation test script) is ready-to-use; 4) The disclosed testing system provides a Low-Code-No-Code solution for creating test scripts, which helps write testcases faster. An example embodiment uses Java™ Selenium™ with the help of utterances to generate automation test scripts; 5) The disclosed testing system reduces the requirement for skilled automation engineers in a project; and 6) The disclosed testing system provides an easy to use interface with auto suggestions for utterances and a locator repository, which leads to reduced turnaround time for test script design and improved productivity.

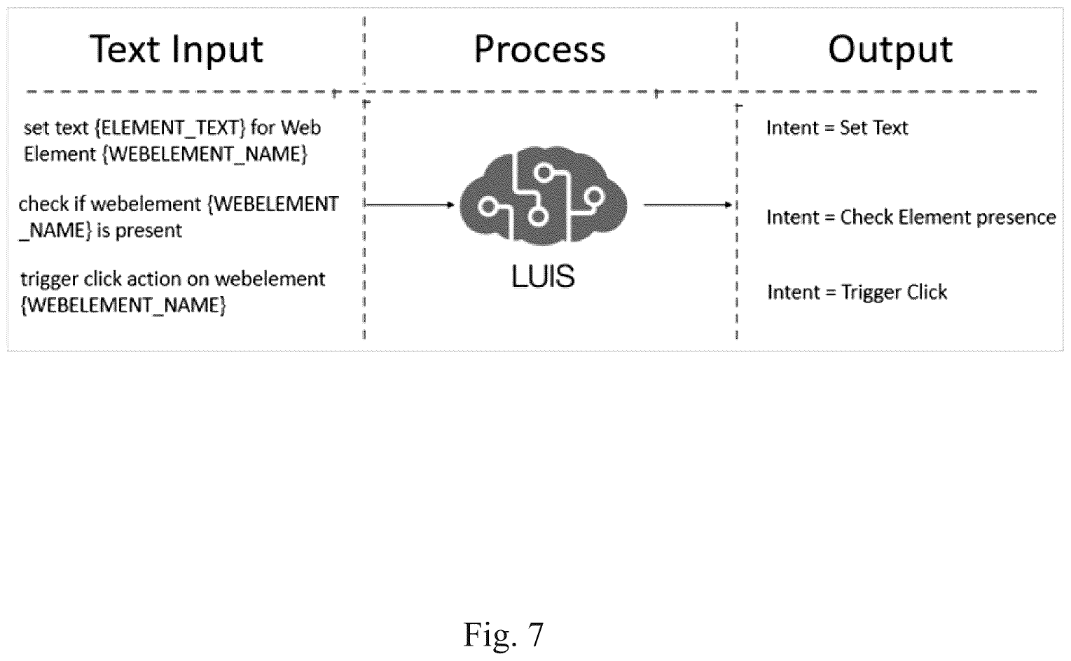

FIG. 7 illustrates an example embodiment implemented using the LUIS™ API service in the Automated Software Testing System framework. It will be apparent to those of ordinary skill in the art that other conventional language processing interfaces can be similarly used. In the Automated Software Testing System disclosed herein, user input to the framework can be provided as written text or spoken utterances. As described in more detail below, the user input can be decoded to cause the Automated Software Testing System to name a web element to a specified name, determine if a web element is present in the utterance library, or trigger an action on a specified web element. In the example embodiment, the LUIS™ API can be used to decode the user inputs. As a result of the input processing performed by the Automated Software Testing System, a downloadable and machine executable test script file can be generated as output.

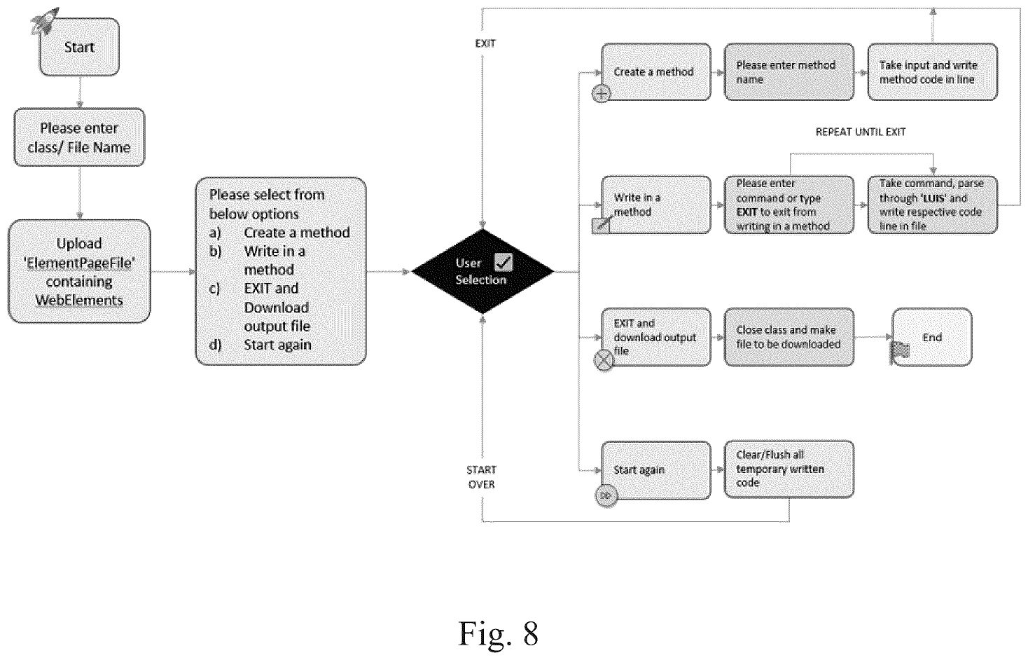

FIG. 8 illustrates a processing flowchart in an example embodiment. The Automated Software Testing System disclosed herein provides a user interface wherein a user can be prompted to enter a class or file name of the web elements repository file to be uploaded for the webpage under consideration. The user can be further prompted to select from a variety of options including options to: a) create a method, b) write in a method, c) exit and download the output file, or d) start again. If the user selects option a), the user can be further prompted to enter a method name. The Automated Software Testing System can accept the method name and include the executable code corresponding to the method name as part of the output script. If the user selects option b), the user can be further prompted to enter a command corresponding to the desired written-in method. The Automated Software Testing System can process the user-entered command through the LUIS™ API to parse the command and produce one or more lines of machine executable code corresponding to the user-entered command. The produced lines of machine executable code can be included as part of the output script. If the user selects option c), the Automated Software Testing System can close the class and the corresponding output script and make the output script available for download. If the user selects option d), the Automated Software Testing System can clear or flush all temporary code of the current output script and prompt the user to start again.

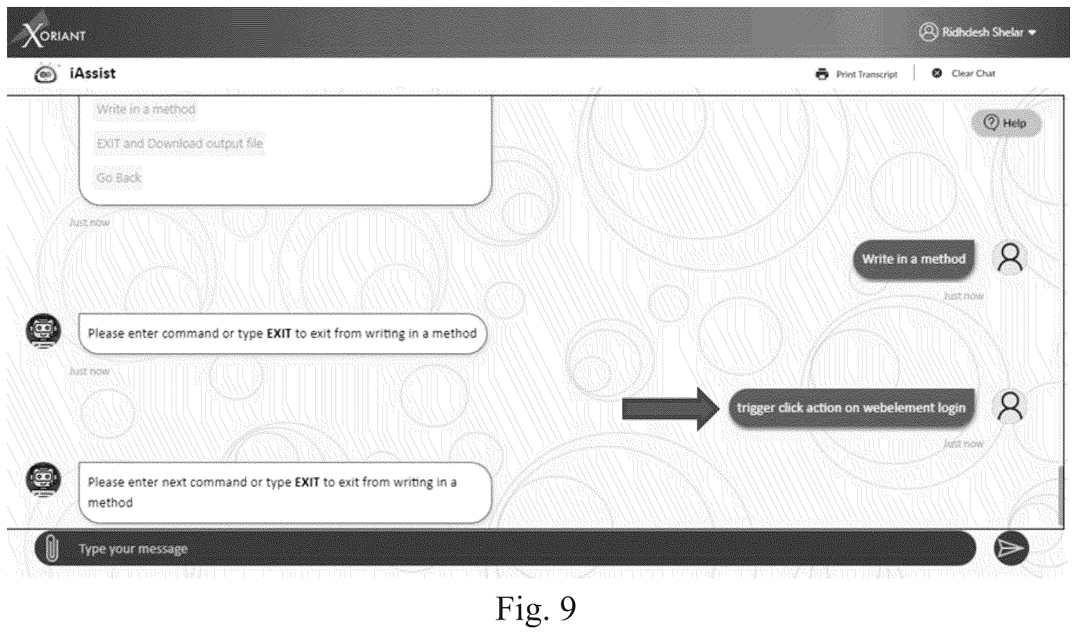

FIGS. 9 through 13 illustrate sample user interface screenshots in use case scenarios of example embodiments of the automated software testing system. Referring to FIG. 9, a use-case is depicted wherein a login flow for a website is automated using the Automated Software Testing System disclosed herein. In the example embodiment, each utterance (command) can be input in plain English text, as spoken utterances in English, or text/spoken utterances in non-English languages. As disclosed herein, the utterance input can be converted to one or more lines of machine executable code at the backend of the process. All these code pieces together will form a testcase, which can be readily integrated in an automation framework. The operational steps in an example are illustrated with screenshots in FIGS. 9 through 13 and elaborated below.

Referring again to FIG. 9 for the illustrated example, a user can provide an utterance as input to the Automated Software Testing System disclosed herein. In this example, the utterance is as follows:
Utterance: Trigger click action on WebElement {WEBELEMENT_NAME}
{WEBELEMENT_NAME}—The user can change this value to the locator of the user interface (UI) field.

In this example as shown in FIG. 9, the WebElement_Name value provided by the user is ‘Login’.

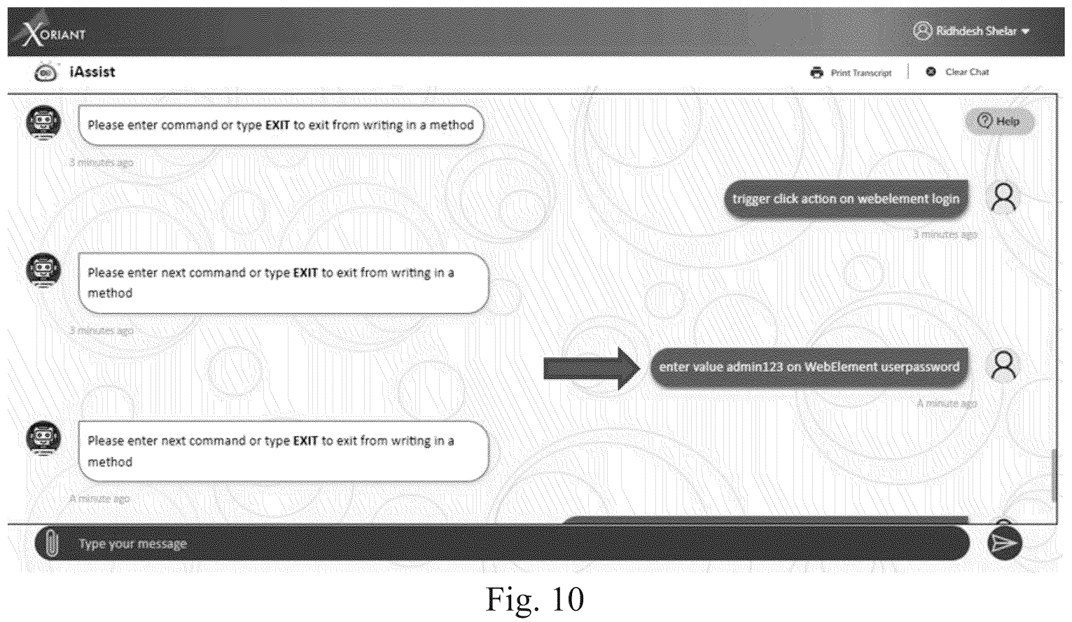

Referring now to FIG. 10 for the illustrated example, a user can provide another utterance as input to the Automated Software Testing System disclosed herein. In this example, the utterance is as follows:
Utterance: Enter value {TEXTTOTYPE} on WebElement {WEBELEMENT}
a. {TEXTTOTYPE}—The user can change the value to be input as required by the UI field.
b. {WEBELEMENT}—The user can change this value to the locator of the UI field.

In this example as shown in FIG. 10, the TextToType value provided by the user is ‘admin123’. The WebElement value provided by the user is ‘userpassword’.

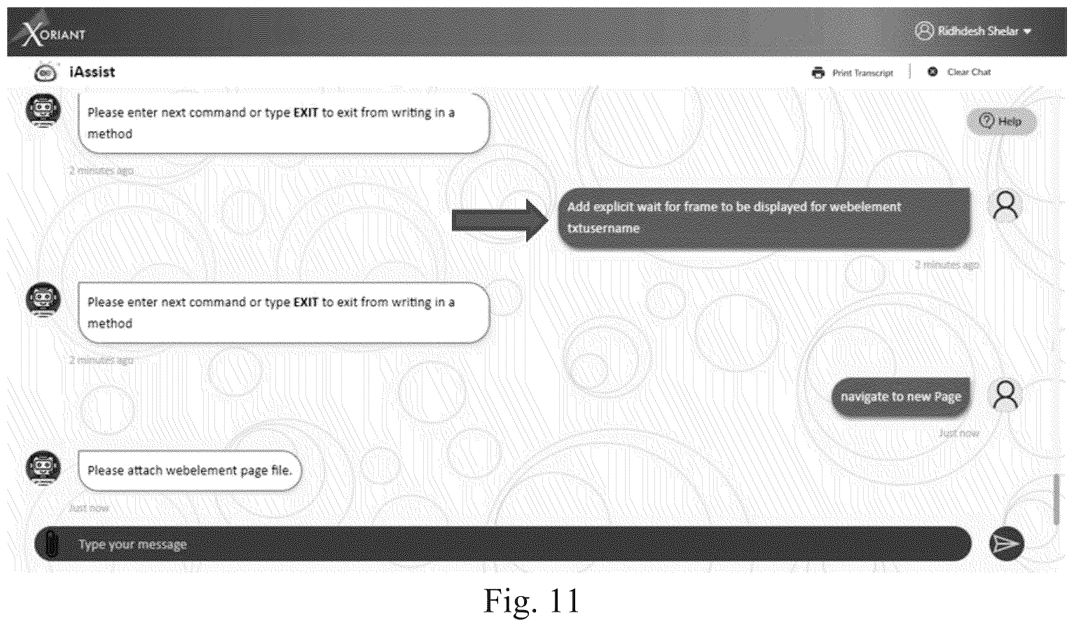

Referring now to FIG. 11 for the illustrated example, a user can provide another utterance as input to the Automated Software Testing System disclosed herein. In this example, the utterance is as follows:
Utterance: Add explicit wait for frame to be displayed for WebElement
{WEBELEMENT_NAME}

In this example as shown in FIG. 11, the WebElement_Name value provided by the user is ‘txtusername’.

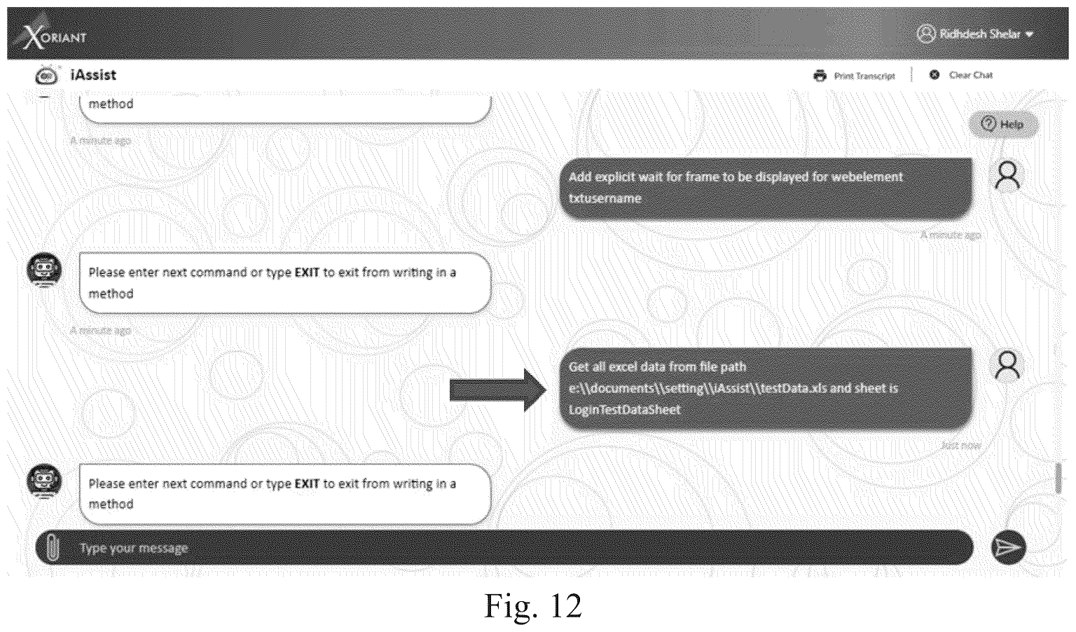

Referring now to FIG. 12 for the illustrated example, a user can provide another utterance as input to the Automated Software Testing System disclosed herein. In this example, the utterance is as follows:
Utterance: Get all excel data from file path {FILE_PATH} and sheet is {SHEET_NAME}

In this example as shown in FIG. 12, the File_Path value provided by the user is ‘e:\\documents\\setting\\iAssist\\testData.xls’. The Sheet_Name value provided by the user is ‘LoginTestDataSheet’.

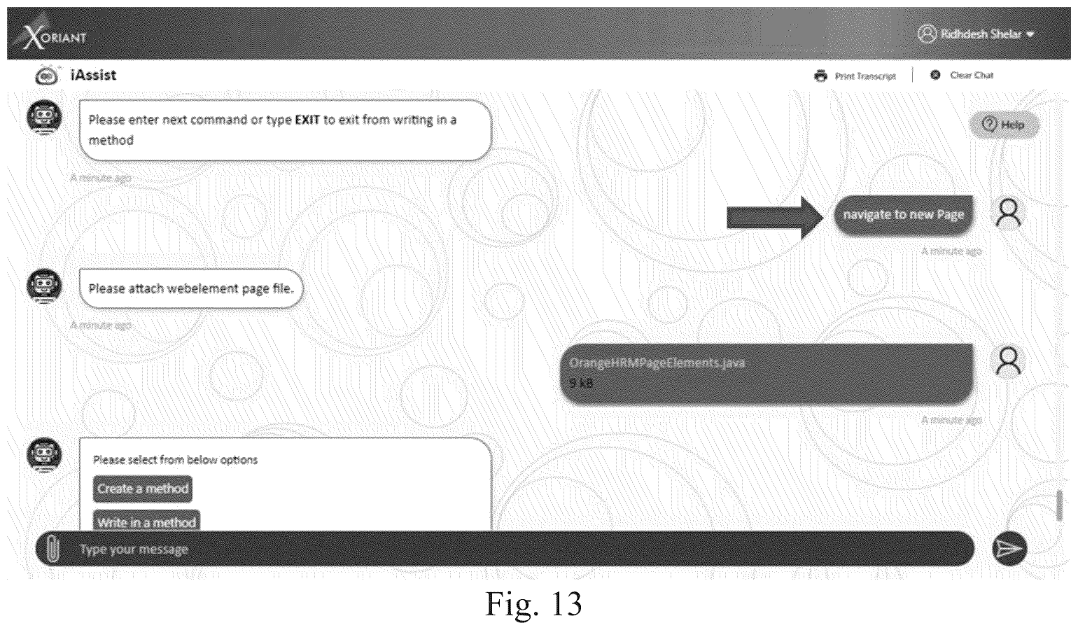

Referring now to FIG. 13 for the illustrated example, a user can provide another utterance as input to the Automated Software Testing System disclosed herein. In this example, the utterance is as follows:
Utterance: Navigate to new Page

In this example as shown in FIG. 13, the user is directed to a new page in response to this utterance.

Utterances defined in the chatbot of the example embodiment, such as those shown in the examples above, can map to a specific utility method of the automation framework. As a result of this mapping, the code generated by the Automated Software Testing System can be a call to the mapped utility method with corresponding parameters and return types required by the called method.

Based on the series of utterances (commands) that the user provides as input in a chat window and the metadata retrieved from the repository file, a Bot of the Automated Software Testing System can generate a downloadable and machine executable test script file as output (Java™, Python™/Javascript™, C#, etc. depending on the framework used). This test script can be integrated into any framework and can be transformed into a machine executable unit of code. A corresponding code sample of the example utterances shown in the examples above and in FIGS. 9 through 13 is given below:

```
import org.openqa.selenium.*;
import org.testng.*;
import java.util.*;
import com.project.testbase.TestBase;
import com.project.utilities.ControlActions;
import com.project.utilities.ExcelReader;
import com.project.pageobjects.xornet.OrangeHRMPageElements;
import com.project.pageobjects.xornet.GlobalsQAPageElements;
public class TestCaseClass extends TestBase {
  public WebDriver driver;
  ControlActions controlActions;
  OrangeHRMPageElements orangeHRMPageElements;
  GlobalsQAPageElements globalsQAPageElements;
  @BeforeTest
  public void setUp( ) throws InterruptedException {
    driver = launchbrowser( );
    controlActions = new ControlActions(driver);
    orangeHRMPageElements = new OrangeHRMPageElements(driver);
    globalsQAPageElements = new GlobalsQAPageElements(driver);
  }
  @AfterTest
  public void tearDown( ) {
    this.driver.quit( );
  }
  @Test
  public void TestMethod( ) {
    ExcelReader excelRd=new ExcelReader( );
        HashMap<String,HashMap> allData=new
  HashMap<String,HashMap>( );try
    {
      allData =
excelRd.ReadAllDataFromExcelSheet(“e:\\documents\\setting\\iAssist\\testData.xls”,
“LoginTestDataSheet”);
    }
    catch (Exception e)
    {
      logError(e.getMessage( ));
    }
    controlActions.clickbutton(orangeHRMPageElements.Login);
    //iAssist recommend to externalize below data
    controlActions.sendKeys(orangeHRMPageElements.userpassword,
  “admin123”);
    WebDriverWait wait = new WebDriverWait(driver, 10);
  wait.until(ExpectedConditions.frameToBeAvailableAndSwitchToIt(orangeHRMPageEle
ments.txtusername));
  }
}
```

The various example embodiments described herein provide several advantages over conventional systems including: 1) Code is generated in a standard way, hence best practices of coding standards are automatically followed, and a code review process can be eliminated; 2) This solution gives the user complete freedom to change code for further customized enhancements; 3) The described Automated Software Testing System has a facility to integrate with any automation framework and make use of its custom functions/methods to form utterances for the chatbot; and 4) The described Automated Software Testing System can be implemented and utilized by many novice automation engineers. As a result, there is a reduction by at least 50% in automation design (e.g., coding, review, and testing) efforts.

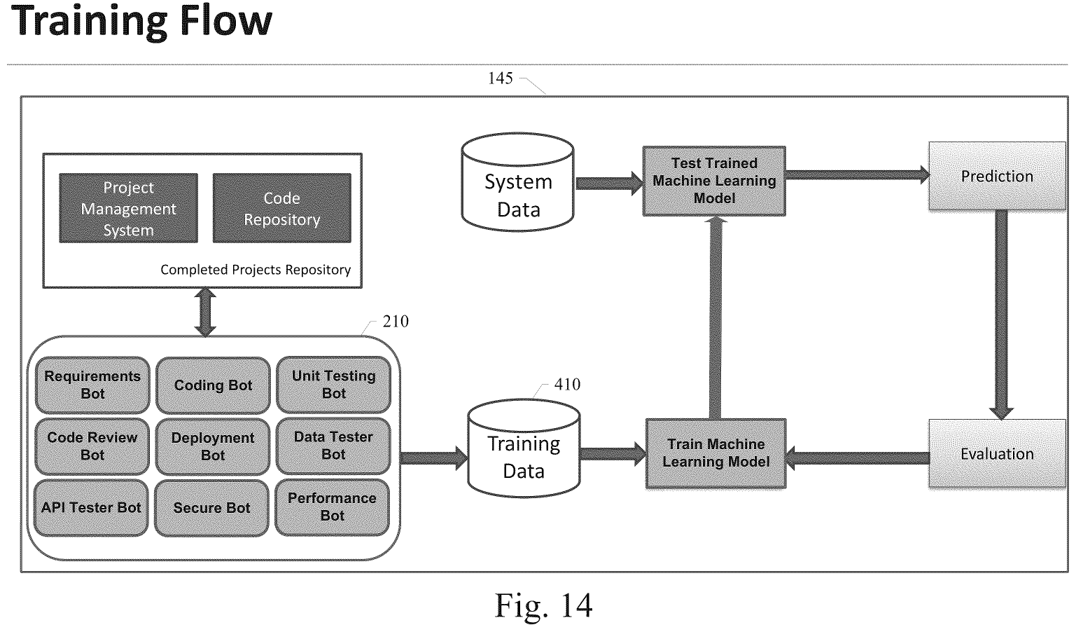

FIG. 14 illustrates an example embodiment showing a training system platform 145 and a process for training each of the bots in the collection of bots 210. As described above, each of the bots in the collection of bots 210 can be implemented using machine learning techniques, trained deep neural networks, classifiers, or other types of trainable execution models. These types of trainable execution models require that the models be initial trained using applicable training data sets to cause the models to converge on results in a desired manner. As shown in FIG. 14, any of the bots in the bot collection 210 can be machine learning models trained using training data 410. The training data 410 can be sample code portions, sample test data, interface data, performance or metrics data, or the like. The trained machine learning models can be tested using applicable system data to produce predicted or desired output. The output of each model is evaluated and the model is re-trained until the output of the trained machine learning model is within an acceptable range of a desired or predicted output. At that point, the trained machine learning model can be retained in the bot collection 210 and marked for operational use by the automated software testing system 200 in a real-time scenario.

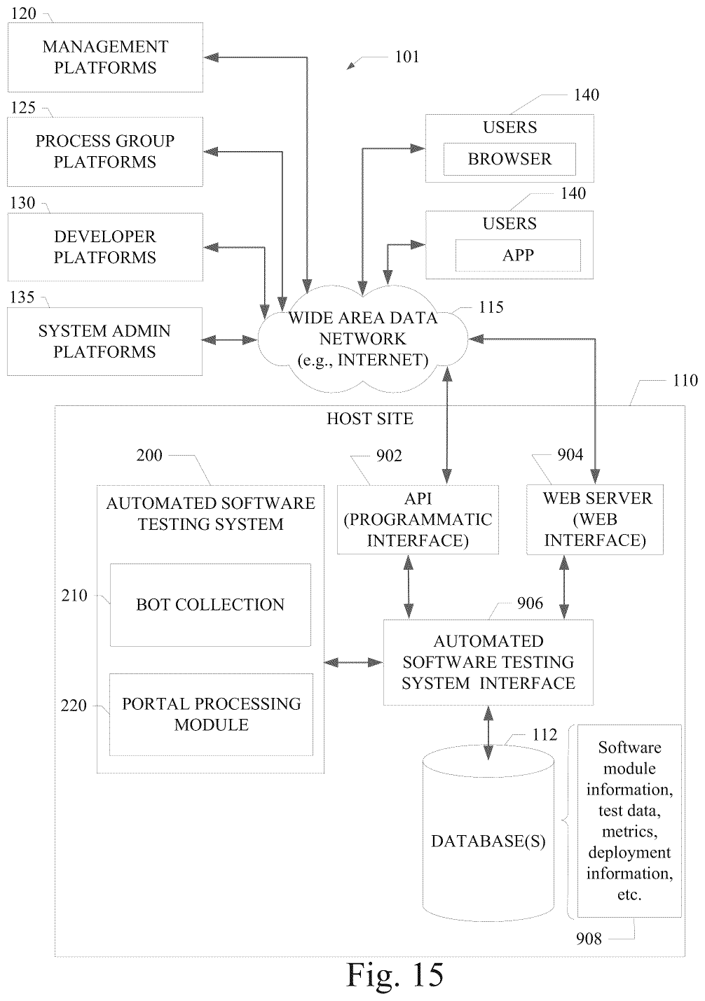

Referring now to FIG. 15, another example embodiment 101 of a networked system in which various embodiments may operate is illustrated. In the embodiment illustrated, the host site 110 is shown to include the automated software testing system 200. The automated software testing system 200 is shown to include the bot collection 210 and the portal processing module 220, as described above. In a particular embodiment, the host site 110 may also include a web server 904, having a web interface with which users may interact with the host site 110 via a user interface or web interface. The host site 110 may also include an application programming interface (API) 902 with which the host site 110 may interact with other network entities on a programmatic or automated data transfer level. The API 902 and web interface 904 may be configured to interact with the automated software testing system 200 either directly or via an interface 906. The automated software testing system 200 may be configured to access a data storage device 112 either directly or via the interface 906.

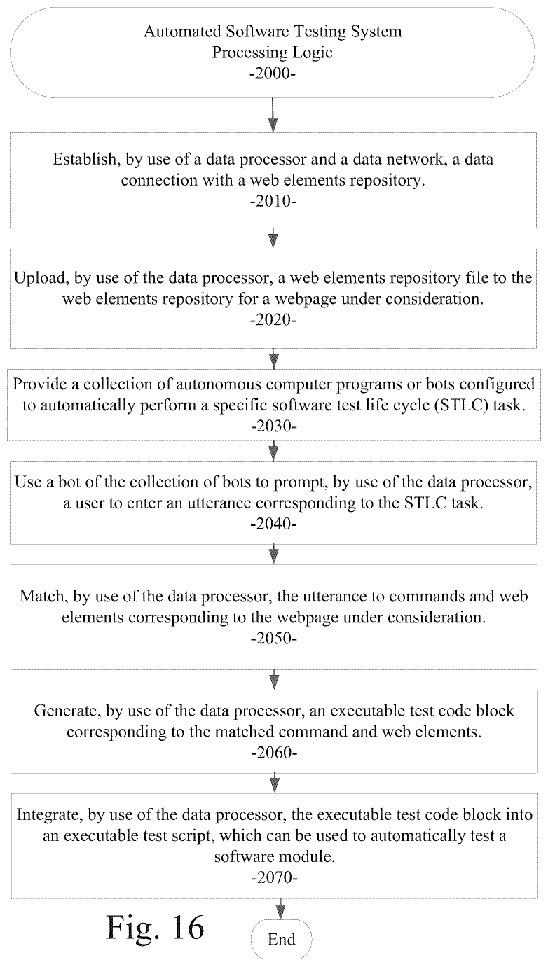

Referring now to FIG. 16, a processing flow diagram illustrates an example embodiment of a method implemented by the automated software testing system 200 as described herein. The method 2000 of an example embodiment includes: establishing, by use of a data processor and a data network, a data connection with a web elements repository (processing block 2010); uploading, by use of the data processor, a web elements repository file to the web elements repository for a webpage under consideration (processing block 2020); providing a collection of autonomous computer programs or bots configured to automatically perform a specific software test life cycle (STLC) task (processing block 2030); using a bot of the collection of bots to prompt, by use of the data processor, a user to enter an utterance corresponding to the STLC task (processing block 2040); matching, by use of the data processor, the utterance to commands and web elements corresponding to the webpage under consideration (processing block 2050); generating, by use of the data processor, an executable test code block corresponding to the matched command and web elements (processing block 2060); and integrating, by use of the data processor, the executable test code block into an executable test script, which can be used to automatically test a software module (processing block 2070).

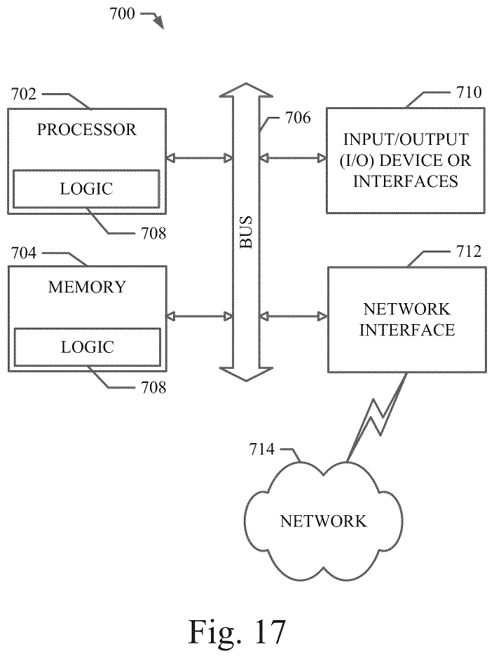

FIG. 17 shows a diagrammatic representation of a machine in the example form of a mobile computing and/or communication system 700 within which a set of instructions when executed and/or processing logic when activated may cause the machine to perform any one or more of the methodologies described and/or claimed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a laptop computer, a tablet computing system, a Personal Digital Assistant (PDA), a cellular telephone, a smartphone, a mobile device, a web appliance, a network router, switch or bridge, or any machine capable of executing a set of instructions (sequential or otherwise) or activating processing logic that specify actions to be taken by that machine. Further, while only a single machine is illustrated, the term “machine” can also be taken to include any collection of machines that individually or jointly execute a set (or multiple sets) of instructions or processing logic to perform any one or more of the methodologies described and/or claimed herein.

The example mobile computing and/or communication system 700 includes a data processor 702 (e.g., a System-on-a-Chip (SoC), general processing core, graphics core, and optionally other processing logic) and a memory 704, which can communicate with each other via a bus or other data transfer system 706. The mobile computing and/or communication system 700 may further include various input/output (I/O) devices and/or interfaces 710, such as a touchscreen display and optionally a network interface 712. In an example embodiment, the network interface 712 can include one or more radio transceivers configured for compatibility with any one or more standard wireless and/or cellular protocols or access technologies (e.g., 2nd (2G), 2.5, 3rd (3G), 4th (4G) generation, and future generation radio access for cellular systems, Global System for Mobile communication (GSM), General Packet Radio Services (GPRS), Enhanced Data GSM Environment (EDGE), Wideband Code Division Multiple Access (WCDMA), LTE, CDMA2000, WLAN, Wireless Router (WR) mesh, and the like). Network interface 712 may also be configured for use with various other wired and/or wireless communication protocols, including TCP/IP, UDP, SIP, SMS, RTP, WAP, CDMA, TDMA, UMTS, UWB, WiFi, WiMax, Bluetooth™, IEEE 802.11x, and the like. In essence, network interface 712 may include or support virtually any wired and/or wireless communication mechanisms by which information may travel between the mobile computing and/or communication system 700 and another computing or communication system via network 714.

The memory 704 can represent a machine-readable medium on which is stored one or more sets of instructions, software, firmware, or other processing logic (e.g., logic 708) embodying any one or more of the methodologies or functions described and/or claimed herein. The logic 708, or a portion thereof, may also reside, completely or at least partially within the processor 702 during execution thereof by the mobile computing and/or communication system 700. As such, the memory 704 and the processor 702 may also constitute machine-readable media. The logic 708, or a portion thereof, may also be configured as processing logic or logic, at least a portion of which is partially implemented in hardware. The logic 708, or a portion thereof, may further be transmitted or received over a network 714 via the network interface 712. While the machine-readable medium of an example embodiment can be a single medium, the term “machine-readable medium” should be taken to include a single non-transitory medium or multiple non-transitory media (e.g., a centralized or distributed database, and/or associated caches and computing systems) that stores the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

As described herein for various example embodiments, a system and method for automated test script code generation for software quality assurance are disclosed. In the various example embodiments described herein, a computer-implemented tool or software application (app) as part of an automated software testing system is described to automate and improve the STLC. As such, the various embodiments as described herein are necessarily rooted in computer and network technology and serve to improve these technologies when applied in the manner as presently claimed. In particular, the various embodiments described herein improve the use of servers or mobile device technology and data network technology in the context of automated software engineering via electronic means.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A computer-implemented method comprising:
establishing, by use of a data processor and a data network, a data connection with a web elements repository;
uploading, by use of the data processor, a web elements repository file to the web elements repository for a webpage under consideration;
providing a collection of autonomous computer programs or bots configured to automatically perform a specific software test life cycle (STLC) task;
using a bot of the collection of bots to prompt, by use of the data processor, a user to enter an utterance corresponding to the STLC task;
matching, by use of the data processor, the utterance to commands and web elements corresponding to the webpage under consideration;
generating, by use of the data processor, an executable test code block corresponding to the matched command and web elements; and
integrating, by use of the data processor, the executable test code block into an executable test script, which can be used to automatically test a software module.

2. The method of claim 1 wherein the bot is a chatbot.

3. The method of claim 1 further including integrating an automation testing framework with the bot to enable library methods of the automation testing framework to be available to the bot.

4. The method of claim 1 wherein the utterance is a spoken or typed utterance.

5. The method of claim 1 wherein prompting the user to enter an utterance further includes prompting the user to: a) create a method, b) write in a method, c) exit and download an output file, or d) start again.

6. The method of claim 1 further including using a second bot of the collection of bots to automatically generate unit test cases for testing the software module.

7. The method of claim 1 further including using a bot of the collection of bots to automatically generate application programming interface (API) test cases and to perform testing of the API.

8. The method of claim 1 wherein at least one bot of the collection of bots is a trained machine learning model.

9. The method of claim 1 including training at least one machine learning model bot of the collection of bots using training data.

10. An automated software testing system comprising:
a data processor;
a network interface, in data communication with the data processor, for communication on a data network; and
an automated software testing system, executable by the data processor, to:
establish a data connection with a web elements repository;
upload a web elements repository file to the web elements repository for a webpage under consideration;
provide a collection of autonomous computer programs or bots configured to automatically perform a specific software test life cycle (STLC) task;
use a bot of the collection of bots to prompt a user to enter an utterance corresponding to the STLC task;
match the utterance to commands and web elements corresponding to the webpage under consideration;
generate an executable test code block corresponding to the matched command and web elements; and
integrate the executable test code block into an executable test script, which can be used to automatically test a software module.

11. The automated software testing system of claim 10 wherein the bot is a chatbot.

12. The automated software testing system of claim 10 being further configured to integrate an automation testing framework with the bot to enable library methods of the automation testing framework to be available to the bot.

13. The automated software testing system of claim 10 wherein the utterance is a spoken or typed utterance.

14. The automated software testing system of claim 10 wherein prompting the user to enter an utterance further includes prompting the user to: a) create a method, b) write in a method, c) exit and download an output file, or d) start again.

15. The automated software testing system of claim 10 being further configured to use a second bot of the collection of bots to automatically generate unit test cases for testing the software module.

16. The automated software testing system of claim 10 being further configured to use a bot of the collection of bots to automatically generate application programming interface (API) test cases and to perform testing of the API.

17. The automated software testing system of claim 10 wherein at least one bot of the collection of bots is a trained machine learning model.

18. The automated software testing system of claim 10 being further configured to train at least one machine learning model bot of the collection of bots using training data.

19. A non-transitory machine-useable storage medium embodying instructions which, when executed by a machine, cause the machine to:
establish, by use of a data processor and a data network, a data connection with a web elements repository;
upload, by use of the data processor, a web elements repository file to the web elements repository for a webpage under consideration;
provide a collection of autonomous computer programs or bots configured to automatically perform a specific software test life cycle (STLC) task;
use a bot of the collection of bots to prompt, by use of the data processor, a user to enter an utterance corresponding to the STLC task;
match, by use of the data processor, the utterance to commands and web elements corresponding to the webpage under consideration;
generate, by use of the data processor, an executable test code block corresponding to the matched command and web elements; and
integrate, by use of the data processor, the executable test code block into an executable test script, which can be used to automatically test a software module.

20. The non-transitory machine-useable storage medium of claim 19 being further configured to integrate an automation testing framework with the bot to enable library methods of the automation testing framework to be available to the bot.
